(19) United States
(12) Patent Application Publication
(10) Pub. No.: US 2024/0254823 A1
(43) Pub. Date: Aug. 1, 2024

(54) DOOR DEVICE

(71) Applicant: HONDA MOTOR CO., LTD., Tokyo (JP)

(72) Inventors: Atsushi NAKASHIMA, Tokyo (JP); Mitsunori NISHINO, Tokyo (JP); Toshihiro KANEDA, Tokyo (JP); Akira KAMIKURA, Tokyo (JP); Riki TOYOOKA, Tokyo (JP); Makoto ONO, Tokyo (JP); Koji MASUDA, Tokyo (JP); Yoichi KATAYAMA, Tokyo (JP); Tsukasa KISHIDA, Tokyo (JP); Koji NOMURA, Tokyo (JP)

(21) Appl. No.: 18/425,319

(22) Filed: Jan. 29, 2024

(30) Foreign Application Priority Data
Jan. 30, 2023 (JP) 2023-011616

(51) Int. Cl. E05F 15/611; E05F 15/70

(52) U.S. Cl. CPC E05F 15/611; E05F 15/70; E05Y 2400/36; E05Y 2900/531

(57) ABSTRACT

A door device includes: a door swingable relative to a vehicle body; an actuator configured to drive the door to open and close; a controller configured to perform drive control on the actuator; and a door open/close detector configured to detect an opening/closing speed of the door, wherein the controller is configured to: determine whether an opening/closing action to be performed on the door is a manual action, in which the door is to be manually opened or closed by a user, or an automatic action, in which the door is to be automatically opened or closed by the actuator; and while the manual action is being performed, learn the opening/closing speed detected by the door open/close detector to generate learned value data including information on the opening/closing speed and to reflect the learned value data to the drive control on the actuator while the automatic action is being performed.

### CROSS REFERENCE TO RELATED APPLICATIONS

This application claims foreign priority to Japanese Patent Application No. 2023-011616, filed Jan. 30, 2023, the disclosure of which is incorporated herein by reference in its entirety.

### TECHNICAL FIELD OF THE INVENTION

The present invention relates to a door device.

### BACKGROUND ART

Efforts have been made in recent years to provide access to sustainable transportation systems friendly to vulnerable traffic participants, such as elderly people and children. To achieve the aim, the efforts are focusing on research and development to further improve the safety and convenience of traffic through development aimed at improving the ease of getting in and out of a vehicle. Conventionally, a door device configured to assist a swing-type door attached via a door swing shaft to open and close by means of an actuator is known (e.g., see Japanese Patent Application Publication No. 2006-028936).

### SUMMARY

In view of improving the ease of getting in and out of a vehicle, it is conceivable to open and close a swing-type door, which can be assisted to open and close by an actuator, by an automatic action without user operation. However, in view of setting an opening/closing speed of the swing-type door so as to suit the preference of a user to perform sustainable development, further improvement is desired.

To address the above-described problem, the present application is aimed at providing a door device capable of varying the door opening/closing speed of a door in an automatic action based on the preference of a user It also aims at contributing to the development of sustainable transportation system.

To solve the above-described problem, a door device of the present invention includes: a door swingable relative to a vehicle body; an actuator configured to drive the door to open and close; a controller configured to perform drive control on the actuator; and a door open/close detector configured to detect an opening/closing speed of the door. The controller is configured to: determine whether an opening/closing action to be performed on the door is a manual action, in which the door is to be manually opened or closed by a user, or an automatic action, in which the door is to be automatically opened or closed by the actuator; and while the manual action is being performed, learn the opening/closing speed detected by the door open/close detector to generate learned value data including information on the opening/closing speed and to reflect the learned value data to the drive control on the actuator while the automatic action is being performed.

The present invention provides a door device capable of varying the door opening/closing speed of a door in an automatic action based on the preference of a user

### BRIEF DESCRIPTION OF THE DRAWINGS

FIG. 1 is a perspective view in which a door disposed on the right side of a vehicle body is put in a semi-opened state by a door device of an embodiment of the present invention, as seen from the rear.

FIG. 2 is a block diagram illustrating the overall configuration of the door device of the embodiment.

FIG. 3 is a flowchart illustrating the basic control of the door device.

FIG. 4 is a graph illustrating a relationship between the door opening degree and the opening/closing speed when the door is opened by a basic automatic action of the door device.

FIG. 5 is a graph illustrating a relationship between the door opening degree and the opening/closing speed when the door is closed by the basic automatic action of the door device.

FIG. 6 is a graph illustrating a relationship between the door opening degree and the opening/closing speed when the door is opened from a semi-opened state by an automatic action.

FIG. 7 is a graph illustrating the relationship between the door opening degree and the opening/closing speed when the door is closed from a semi-closed state by an automatic action.

FIG. 8 is a graph illustrating the relationship between the door opening degree and the opening/closing speed when the door is closed by an automatic action when the user is outside the vehicle compartment.

FIG. 9 is a flowchart illustrating control of the door device learning a manual action multiple times.

FIG. 10 is a flowchart illustrating control of the door device that performs learning based on the tilt angle of the vehicle body.

FIG. 11 is a flowchart illustrating control of the door device that performs learning based on the opening/closing speed of the door.

### DETAILED DESCRIPTION OF EMBODIMENT

### Embodiment

Subsequently, an embodiment of the present invention is described with reference to the drawings as appropriate. In the description, the same elements are denoted by the same reference numerals, and overlapping descriptions will be omitted. When a direction is described, description is given based on the front, rear, left, right, up, and down directions as seen from the driver of the vehicle. Note that, herein, the vehicle width direction and the lateral direction are synonymous. In addition, herein, the front-rear direction and the longitudinal direction are synonymous.

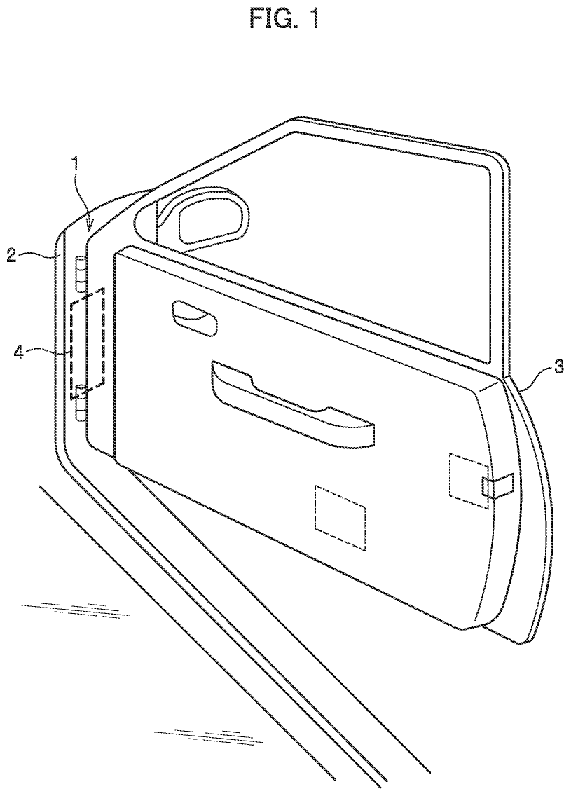

FIG. 1 illustrates a vehicle to which the present invention is applied. FIG. 1 is a perspective view in which a door 3 disposed on the right side of a vehicle body 2 is put in a semi-opened state, as seen from the rear in the vehicle compartment. A door device 1 of the embodiment includes a door 3 that swings around a hinge with respect to the vehicle body 2 and an actuator 4 that drives the door 3 to open and close.

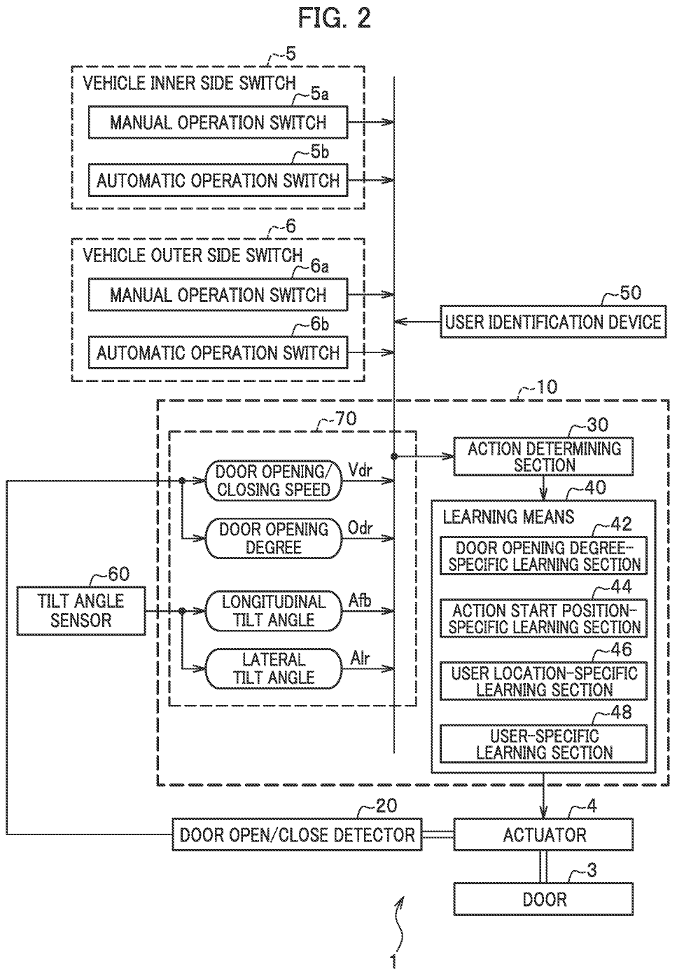

As shown in FIG. 2, the door device 1 includes: a controller (a door Electronic Control Unit (ECU)) 10 that outputs a control signal for performing drive control on the actuator 4 to the actuator 4; a door open/close detector 20 that detects the opening/closing speed of the door 3; a user identification device 50 capable of recognizing a plurality of users separately; and a tilt angle sensor 60 that detects a tilt angle of the vehicle body 2 and outputs a detection signal representing the tilt angle to the controller 10.

The actuator 4 includes: a motor actuator (not shown) that rotationally drives a rotation shaft based on the input control signal; and a deceleration mechanism (not shown) that decelerates or converts the rotational driving force of the rotation shaft of the motor actuator to generate a rotating force causing the door 3 to swing.

The actuator 4 alters, in response to the control signal, the rotation speed of the rotation shaft of the motor actuator. With this, when causing the door 3 to open or close, the opening/closing speed of the door 3 can be controlled to a desired door opening/closing speed Vdr.

The door open/close detector 20 is constructed including a Hall sensor for detecting the state of the rotation shaft of the motor actuator. The Hall sensor detects the magnetic field variation caused by the rotation of the rotation shaft to be converted into an electrical signal. The door open/close detector 20 amplifies the electrical signal to a detection signal including information on the rotation speed of the rotation shaft or the rotational position of the rotation shaft, and outputs the detection signal to the controller 10.

The controller 10 includes an action determining section 30, learning means 40, and a computation section 70. For example, when the action determining section 30 determines a manual action is in progress, the learning means 40 detects the opening/closing speed of the door 3 and calculates an average value by averaging the detected values over a plurality of manual actions to use as learned value data.

Here, the manual action means that the opening/closing action of the door 3 is performed manually by the user. The manual action includes an assist action of the actuator 4 assisting the door 3 to open and close. The assist action here means an action of the actuator 4 decreasing an open/close load though not capable of moving the door 3 only by the actuator 4.

The computation section 70 converts the detection signal detected by the door open/close detector 20 into values of door opening/closing speed Vdr and door opening degree Odr. The tilt angle sensor 60 of the embodiment is constructed including an acceleration sensor. The tilt angle sensor 60 converts the detection signal to the values of a longitudinal tilt angle Afb and a lateral tilt angle Alr.

These values of the door opening/closing speed Vdr, door opening degree Odr, longitudinal tilt angle Afb, and lateral tilt angle Alr are learned by the learning means 40 as learned value data.

The learned value data is reflected to a control signal for causing the door 3 to open with an automatic action or to close with an automatic action. Here, the automatic action means that the door 3 automatically opens or closes by means of the actuator 4. In this situation, the controller 10 feeds back the state of the rotation shaft at the time of detection from the detection signal detected by the door open/close detector 20 to generate a control signal. Then, the learning means 40 outputs this control signal to the actuator 4. With this, the actuator 4 causes the door 3 to swing at the desired door opening/closing speed Vdr at each door opening degree Odr.

The action determining section 30 determines whether a manual action is to be performed or an automatic action, in which an open or close action is automatically performed by the actuator 4, is to be performed.

Specifically, a vehicle inner side switch 5 and a vehicle outer side switch 6 are respectively disposed on the vehicle inner side and the vehicle outer side of the door 3 and are connected to the action determining section 30.

When the vehicle inner side switch 5 is operated by a user, the action determining section 30 determines that the user is in the vehicle compartment. Similarly, when the vehicle outer side switch 6 is operated by a user, the action determining section 30 determines that the user is outside the vehicle compartment.

The vehicle inner side switch 5 includes a manual operation switch 5a and an automatic operation switch 5b. The vehicle outer side switch 6 includes a manual operation switch 6a and an automatic operation switch 6b.

The action determining section 30 determines that, when either the manual operation switch 5a or 6A is operated by a user, a manual action, in which an opening/closing action of the door 3 is manually performed by the user, is to be performed. In addition, when the door 3 start to open or close without the automatic operation switches 5b and 6b being operated, the action determining section 30 also determines that a manual action is to be performed. The action determining section 30 determines that, when either the automatic operation switch 5b or 6b is operated by a user, an automatic action, in which the door 3 is automatically opened or closed by the actuator 4, is to be performed.

While a manual action is being performed, the learning means 40 performs learning using the door opening/closing speed Vdr detected by the door open/close detector 20. The learning means 40 reflects the learned result to the drive control on the actuator 4 when performing an automatic action. The learning means 40 of the embodiment performs learning when the door opening/closing speed Vdr is less than or equal to a predetermined value. In addition, the learning means 40 performs learning when a tilt angle of the vehicle body 2, which is based on the detection values output from the tilt angle sensor 60, is less than or equal to a predetermined value.

The learning means 40 includes a door opening degree-specific learning section 42, an action start position-specific learning section 44, a user location-specific learning section 46, and a user-specific learning section 48.

The door opening degree-specific learning section 42 learns the values of the door opening/closing speed Vdr in relation to the values of door opening degree Odr of door 3 detected by the door open/close detector 20 and organizes the learned value data to include opening degree-specific learned value data in which the values of the door opening/closing speed Vdr are associated with the values of door opening degree Odr. Then, when performing an automatic action, the controller 10 reflect, of the opening degree-specific learned value data, a door opening/closing speed Vdr corresponding to the current door opening degree Odr of the door 3 to the drive control on the door 3.

The action start position-specific learning section 44 learns, for each action start position of the door 3 from which a manual action has started, the values of the door opening/closing speed Vdr in relation to the values of door opening degree Odr and organizes the learned value data to include position-specific learned value data in which the values of the door opening/closing speed Vdr are associated with the values of door opening degree Odr for each action start position. In other words, the action start position-specific learning section 44 organizes the above-described opening degree-specific learned value data per each action start position. When starting an automatic action, the controller 10 may reflect, of the position-specific learned value data, opening degree-specific learned value data corresponding to the current action start position of the door 3 to the drive control on the door 3.

The user location-specific learning section 46 organizes the learned value data on a per-user location basis. Specifically, user location-specific learning section 46, based on the location determined by the action determining section 30, performs learning and organizes the learned value data to include user location-specific learned value data in which the above-described opening degree-specific learned value data and the above-described position-specific learned value data are each distinguished between cases when the user is inside the vehicle compartment and when the user is outside the vehicle compartment. Then, when performing an automatic action, the controller 10 may reflect, of the user location-specific learned value data, data (the above-described opening degree-specific learned value data or the above-described position-specific learned value data) corresponding to the current location of the user to the drive control on the door 3.

The user-specific learning section 48 organizes the learned value data on a per-user basis. Specifically, the user-specific learning section 48, for each user recognized by the user identification device 50, performs learning on a per-user basis and organizes the learned value data to include user-specific learned value data in which the above-described opening degree-specific learned value data, the above-described position-specific learned value data, and the user location-specific learned value data are distinguished per user.

Then, when performing an automatic action, the controller 10 may reflect, of the user-specific learned value data, data (the above-described opening degree-specific learned value data, the above-described position-specific learned value data, or the user location-specific learned value data) corresponding to the current user to the drive control on the door 3.

Next, description will be given of control using the door device 1 of the embodiment while referencing to FIG. 2.

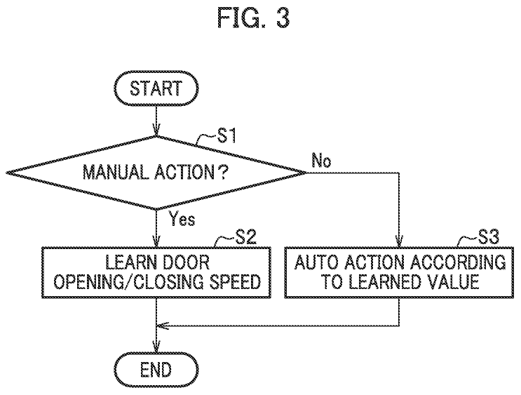

FIG. 3 illustrates basic control on the door 3.

In step S1, the action determining section 30 of the controller 10 determines whether the door 3 is being opened or closed by a manual action. When either the manual operation switch 5a or 6a of the door 3 is operated by the user, the action determining section 30 determines that the door 3 is being opened or closed by a manual action (Yes at step S1) and the flow proceeds to step S2.

In step S2, the learning means 40 performs learning multiple times the values of the door opening/closing speed Vdr having been converted by the computation section 70. Specifically, the learning means 40 generates, for example, average values of the converted values as learned value data and stores the learned value data into a not-shown storage section. The learning means 40 reads out the learned value data and reflect it to the control signal, as needed.

In step S1, when any one of the automatic operation switches 5b and 6b of the door 3 is operated by a user, the action determining section 30 determines that the door 3 is to be opened or closed by an automatic action (No at step S1) and the flow proceeds to step S3.

In step S3, the learned value data generated by the learning means 40 is reflected to the control signal for causing the door 3 to operate automatically. The controller 10 outputs the control signal to the actuator 4. With this, when the user operates the automatic operation switch 5b or 6b, the actuator 4 imparts a rotating force to the door 3 to cause the door 3 to swing.

For example, when the automatic operation switch 5b or 6b is operated in a state of the door 3 having been closed, the door 3 swings in a direction toward an open position. Conversely, when the automatic operation switch 5b or 6b is operated in a state of the door 3 having been opened, the door 3 swings in a direction toward a close position.

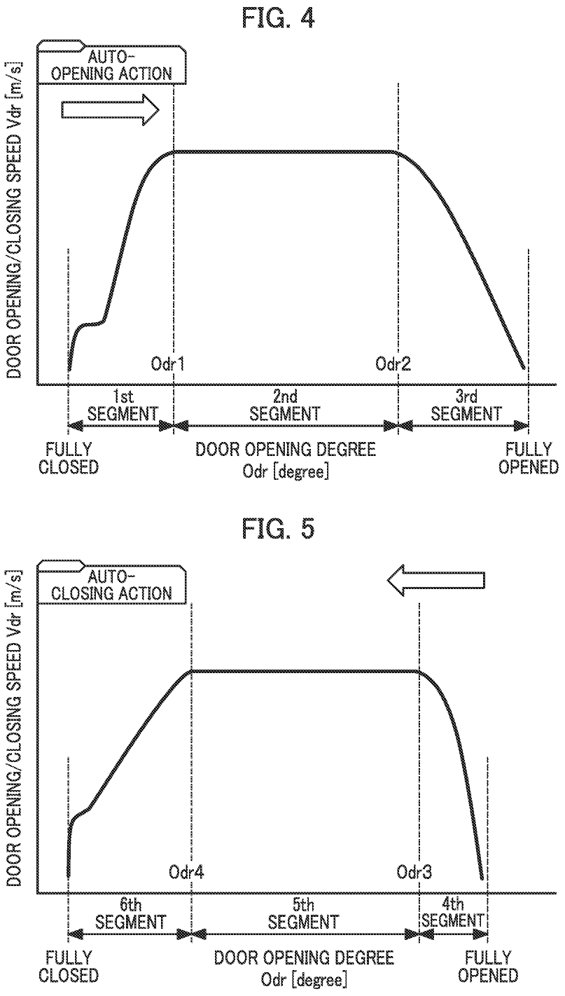

FIG. 4 illustrates an example of control that causes the door 3 to swing by an automatic action in a direction toward a fully opened state from a fully closed state of the door 3 having been closed. As a result of the learning by the learning means 40, the learned value data of the door opening/closing speed Vdr corresponding to the door opening degree Odr1 is given as such a graph. The horizontal and vertical axes of this graph represent the door opening degree Odr [degree] and the door opening/closing speed Vdr [m/s], respectively. The range of the door opening degree Odr is divided into three segments of the 1st segment to the 3rd segment, from the fully closed state at the left side of the drawing to the fully opened state at the right side of the drawing. The boundary between the 1st segment and 2nd segment is defined as door opening degree Odr1 [degree], and the boundary between the 2nd segment and 3rd segment is defined as door opening degree Odr2 [degree].

When, in a fully closed state, the control signal from the controller 10 is input to the actuator 4, the door 3 starts to swing from the fully closed state in a direction toward an open position. In the 1st segment, the control signal increases the door opening/closing speed Vdr as the door opening degree Odr changes toward door opening degree Odr1. Note that a buffer segment of a constant low speed is provided in the beginning of opening. With this, in the initial stage of the swing action, the rapid rotation of the door 3 is refrained.

In the 2nd segment, the door 3 is caused to swing from door opening degree Odr1 to door opening degree Odr2 at the same door opening/closing speed Vdr. The door opening/closing speed Vdr in the 2nd segment is learned so that the speed is fastest between the 1st segment and the 3rd segment. As a result, the time for the door 3 to be fully opened is reduced.

In the 3rd segment, the control signal decreases the door opening/closing speed Vdr as the door opening degree Odr changes from door opening degree Odr2 toward the fully opened state. With this, the speed of the swing action shortly before reaching the fully opened state is slow, mitigating the impact on the door 3.

FIG. 5 illustrates an example of control that causes the door 3 to swing by an automatic action in a direction toward a close position from the fully opened state to the fully closed state. The range of the door opening degree Odr is divided into three segments of the 4th segment to the 6th segment, from the fully opened state at the right side of the drawing to the fully closed state at the left side of the drawing. The boundary between the 4th segment and 5th segment is defined as door opening degree Odr3 [degree], and the boundary between the 5th segment and 6th segment is defined as door opening degree Odr4 [degree].

When, in a fully opened state, the control signal from the controller 10 is input to the actuator 4, the door 3 starts to swing from the fully opened state in a direction toward a close position. In the 4th segment, the control signal increases the door opening/closing speed Vdr as the door opening degree changes toward door opening degree Odr3. With this, in the initial stage of the swing action, the rapid rotation of the door 3 is refrained.

In the 5th segment, the door 3 is caused to swing from door opening degree Odr3 to door opening degree Odr4 at the same door opening/closing speed Vdr. The door opening/closing speed Vdr in the 5th segment is set so that the speed is fastest between the 4th segment and the 6th segment. As a result, the time for the door 3 to be fully closed is reduced.

In the 6th segment, the control signal decreases the door opening/closing speed Vdr as the door opening degree Odr changes from door opening degree Odr4 toward the fully closed state. With this, the speed of the swing action shortly before reaching the fully closed state is slow, refraining the door 3 from closing rapidly and mitigating the impact on the door 3 and the vehicle body 2.

As described above, the door device 1 of the embodiment includes: a door 3 swingable relative to a vehicle body 2; an actuator 4 configured to drive the door 3 to open and close; a controller 10 configured to perform drive control on the actuator 4; and a door open/close detector 20 configured to detect an opening/closing speed of the door 3. The controller 10 includes: an action determining section 30 configured to determine whether an opening/closing action to be performed on the door 3 is a manual action, in which an open or close action is to be performed manually by a user, or an automatic action, in which an open or close action is automatically performed by the actuator 4; and learning means 40 configured to, while the manual action is being performed, learn the opening/closing speed detected by the door open/close detector 20 to generate learned value data including information on the opening/closing speed and to reflect the learned value data to the drive control on the actuator 4 while the automatic action is being performed.

The door device 1 of the embodiment as configured above is capable of controlling the opening/closing speed of the door 3 based on the preference of the user during an automatic action of the door 3.

In detail, the learning means 40 learns the opening/closing speed of the door 3 while a manual action is being performed. Then, when causing the door 3 to operate automatically, the controller 10 performs drive control on the actuator 4 so that the learned opening/closing speed is reflected to the drive control. As a result, the door 3 operates automatically with a speed close to the speed with which the user would manually open or close the door 3. This means the door 3 opens or closes with a speed preferable to by the user.

The learning means 40 is configured to learn the opening/closing speed per an opening degree of the door 3 to generate the learned value data so as to associate values of the opening/closing speed with values of the opening degree of the door 3. In detail, the learning means 40 includes a door opening degree-specific learning section 42 configured to learn the values of the door opening/closing speed Vdr in relation to the values of door opening degree Odr of door 3 detected by the door open/close detector 20 and organize the learned value data to include opening degree-specific learned value data in which the values of the door opening/closing speed Vdr are associated with the values of door opening degree Odr.

In the case of the embodiment, in an automatic action, the controller 10 outputs a control signal to which the opening degree-specific learned value data generated in an manual action by the door opening degree-specific learning section 42 is reflected, to reflect the opening degree-specific learned value data to the drive control to be performed by the actuator 4 on the door 3.

The opening degree-specific learned value data is a result of learning the door opening/closing speed Vdr corresponding to the door opening degree Odr of the door 3. This information enables opening/closing the door 3 with a speed specific to the opening degree, rather than opening/closing the door 3 with a constant speed from starting the opening of the door 3 until the door 3 is closed. That means it is possible to cause the door 3 to operate automatically to open or close with a speed more in line with the preference of the user.

The learning means 40 is further configured to further learn the opening/closing speed per an action start position of the door 3 from which the manual action has started, to generate the learned value data so as to associate the values of the opening/closing speed further with the action start position. When starting the automatic action, the learning means 40 may reflect, of the learned value data, data corresponding to a current action start position of the door 3 to the drive control on the actuator 4.

Specifically, the learning means 40 includes an action start position-specific learning section 44 configured to learn, for each action start position of the door 3 from which a manual action has started, the values of the door opening/closing speed Vdr in relation to the values of door opening degree Odr and organize the learned value data to include position-specific learned value data in which the values of the door opening/closing speed Vdr are associated with the values of door opening degree Odr for each action start position. Then, when starting an automatic action, the learning means 40 may reflect, of the position-specific learned value data, opening degree-specific learned value data corresponding to the current action start position of the door 3 to the drive control on the actuator 4.

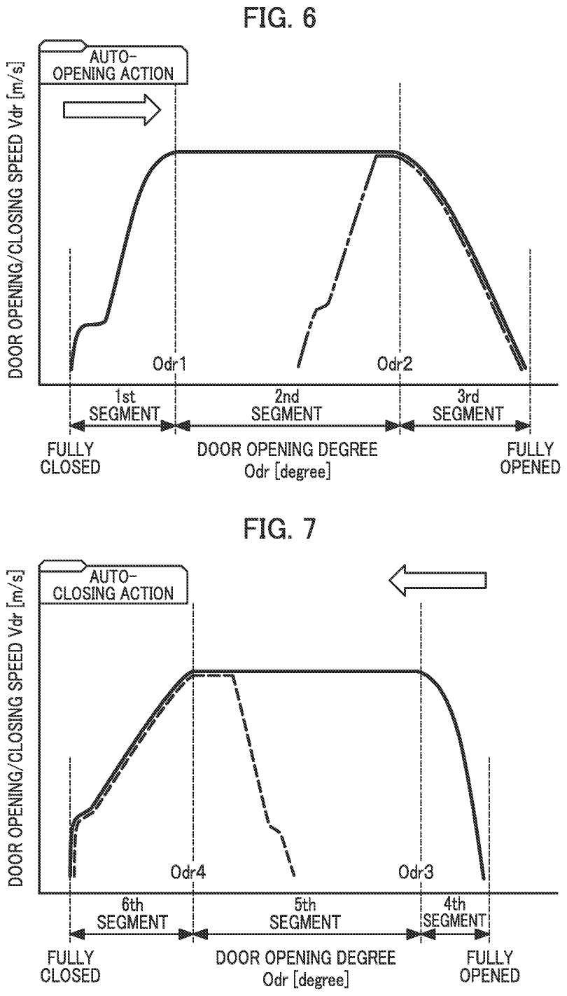

For example, FIG. 6 illustrates, with the alternate long and short dash line, control to cause the door 3 to operate automatically by an automatic action in a direction toward a fully opened state from an intermediate opening degree, so-called a semi-opened state, where the action start position of the door 3 is within the 2nd segment. Note that, for comparison, the solid line shown in FIG. 6 illustrates an automatic action by which the door 3 is driven from a fully closed state in which the door 3 has been closed to a fully opened state (see FIG. 4).

When, in a state of the door opening degree being the intermediate opening degree, the control signal from the controller 10 is input to the actuator 4, the door 3 starts to swing in a direction toward an open position. In the 2nd segment, the control signal increases the door opening/closing speed Vdr as the door opening degree Odr changes toward door opening degree Odr2. Note that a buffer segment of a constant low speed may be provided in the beginning of opening. In a similar manner to that illustrated in FIG. 4, when the door opening/closing speed reaches the fastest door opening/closing speed Vdr set in the 2nd segment, this fastest door opening/closing speed Vdr is maintained. With this, the time for the door 3 to be fully opened is reduced.

In the 3rd segment, the control signal decreases the door opening/closing speed Vdr as the door opening degree Odr of the door 3 changes from door opening degree Odr2 toward the fully opened state. With this, the swing action shortly before reaching the fully opened state slows down, mitigating the impact on the door 3.

The dashed line shown in FIG. 7 illustrates control to cause the door 3 to operate automatically by an automatic action in a direction toward a fully closed state from an intermediate opening degree, so-called a semi-opened state, where the action start position of the door 3 is within the 5th segment. Note that, for comparison, the solid line shown in FIG. 7 illustrates an automatic action by which the door 3 is driven from a fully opened state, in which the door 3 has been fully opened, to a fully closed state (see FIG. 5).

When, in a state of the door opening degree Odr being the intermediate opening degree, the control signal from the controller 10 is input to the actuator 4, the door 3 starts to swing in a direction toward a fully closed position. In the 5th segment, the control signal increases the door opening/closing speed Vdr as the door opening degree Odr changes toward door opening degree Odr4. Note that a buffer segment of a constant low speed may be provided in the beginning of closing. In a similar manner to that illustrated in FIG. 5, when the door opening/closing speed reaches the fastest door opening/closing speed Vdr set in the 5th segment, this fastest door opening/closing speed Vdr is maintained. With this, the time for the door 3 to be fully closed is reduced.

In the 6th segment, the control signal decreases the door opening/closing speed Vdr as the door opening degree Odr of the door 3 changes from door opening degree Odr4 to the fully closed state. With this, the swing action shortly before reaching the fully closed state slows down, mitigating the impact on the door 3.

In this way, even when the opening degree of the door 3 is an intermediate opening degree when starting an automatic action, the door 3 is opened/closed with a door opening/closing speed Vdr not causing a sense of discomfort to the user. Note that when there is no corresponding learned value data (there is no learned value data for the case where the door 3 is fully opened from the semi-opened position), values combining the values for the 1st segment and the 3rd segment or average values of them may be used as the learned value data.

The learning means 40 is further configured to further learn the door opening/closing speed Vdr separately for a case when the user is inside a vehicle compartment and a case when the user is outside the vehicle compartment. Specifically, the learning means 40 includes a user location-specific learning section 46 configured to, based on the user location determined by the action determining section 30, perform learning and organize the learned value data to include user location-specific learned value data in which the above-described opening degree-specific learned value data and the above-described position-specific learned value data are each distinguished between cases when the user is inside the vehicle compartment and when the user is outside the vehicle compartment.

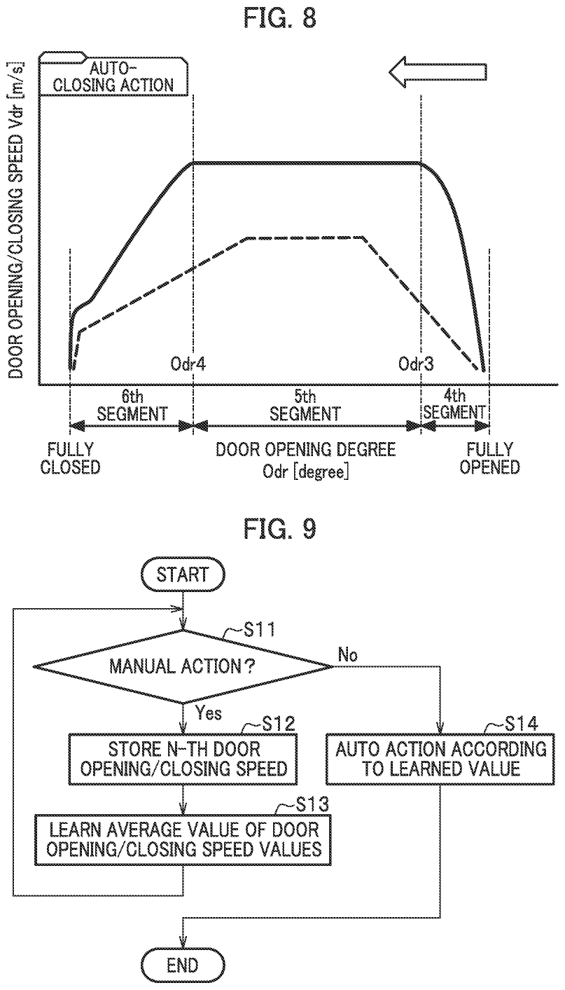

The dashed line shown in FIG. 8 illustrates control to be performed when the action determining section 30 determines that the user is on the indoor side. Note that, for comparison, the solid line shown in FIG. 8 illustrates the control when the user is determined as being on the vehicle outer side (see FIG. 5).

For example, the action determining section 30 determines that the user is on the indoor side when the automatic operation switch 5b, which is disposed on the vehicle inner side, is operated. In a case where the user is determined as being on the indoor side, when the control signal from the controller 10 is input to the actuator 4, the door 3 starts to swing from the fully opened state in a direction toward a fully closed position. In the 4th segment, the control signal increases (see the dashed line) the door opening/closing speed Vdr as the door opening degree Odr changes toward door opening degree Odr3. The ratio of increasing the door opening/closing speed Vdr is set to a smaller value than the case where the user is determined as being on the vehicle outer side (see the solid line).

In the 5th segment, when the door opening/closing speed Vdr reaches a door opening/closing speed lower than a door opening/closing speed for the case where the user is determined as being on the vehicle outer side, the door 3 is caused to swing at the reached door opening/closing speed.

In the 5th segment, prior to the control in the 6th segment, the control signal decreases the door opening/closing speed Vdr as the door opening degree Odr of the door 3 changes from a door opening degree Odr greater than door opening degree Odr4 toward the fully closed state. The ratio of decreasing the door opening/closing speed Vdr is learned so that the ratio is smaller than that in the case when the user is determined as being on the vehicle outer side (see the solid line). With this, the door opening/closing speed Vdr is reduced so that a rapid swing action of the door 3 does not occur in a relatively long segment.

In the 6th segment, the door 3 is caused to swing from door opening degree Odr4 toward a fully closed state while maintaining the ratio of decreasing the door opening/closing speed Vdr in the 5th segment. As a result, the swing action shortly before reaching the fully closed state is slow during a longer time compared to the control when the user is determined as being on the vehicle outer side (see the solid line). Therefore, the impact on the door 3 and the vehicle body 2 is further mitigated.

As the comfort door closing speed differs depending on whether the user is inside or outside the vehicle compartment, maintaining separate learned value data enables closing the door 3 with a door opening/closing speed Vdr more in line with the preference of the user.

When, for example, the user vigorously closes the door 3 from outside the vehicle compartment by a manual action, this action is learned as user location-specific learned value data separate from the case where the user closes the door 3 from inside the vehicle compartment. Then, in an automatic action, the door 3 is closed from inside the vehicle compartment with a door opening/closing speed Vdr learned when the user is on the indoor side, which is a speed different from the door opening/closing speed Vdr at which the door 3 is closed from outside the vehicle compartment. In this way, the user location-specific learned value data is reflected to the control signal so that the door 3 is closed with a door opening/closing speed Vdr comfortable to the user on the indoor side.

The learning means 40 is further configured to calculate an average value of the door opening/closing speed Vdr by averaging values of the door opening/closing speed over a plurality of manual actions and include the average value into the learned value data as the information on the opening/closing speed.

FIG. 9 illustrates a flowchart of control that takes an average value of detected values as the learned value data.

In step S11, the action determining section 30 of the controller 10 determines whether the operation of opening or closing the door 3 is to be performed by a manual action. When either the manual operation switch 5a or 6a of the door 3 is operated by the user, the action determining section 30 determines that an operation of opening or closing the door 3 is to be performed by a manual action (Yes at step S11) and the flow proceeds to step S12.

In steps S12 to S13, the learning means 40 performs learning based on the values of the door opening/closing speed Vdr having been converted by the computation section 70 for a plurality of manual actions. Specifically, in step S12, the learning means 40 stores the N-th values of the door opening/closing speed Vdr to a not-shown storage section. In other words, for the N-th manual action, the learning means 40 stores respective values of door opening/closing speed Vdr for values of door opening degree Odr. In step S13, the learning means 40 computes learned value data including averaged values of door opening/closing speed Vdr respectively corresponding to values of door opening degree Odr by averaging the values of door opening/closing speed Vdr stored in the storage section, over a predetermined number of manual actions. In detail, the averaged values of door opening/closing speed Vdr are used as the values of door opening/closing speed Vdr included in the above-described opening degree-specific learned value data, the above-described position-specific learned value data, the above-described user location-specific learned value data, and the above-described user-specific learned value data. Then the flow returns to step S11.

Note that, in step S13, when the learned value data has not yet been stored for the predetermined number of manual actions, the averaging may be performed over the value data currently stored in the storage section to compute the learned value data.

When either the automatic operation switch 5b or 6b of the door 3 is operated by the user, the action determining section 30 determines that an operation of opening or closing the door 3 is to be performed by an automatic action (No at step S11) and the flow proceeds to step S14.

In step S14, the learning means 40 reflects the learned value data, which has been learned through steps S12 and S13, to the control signal based on which the automatic action is performed.

In this way, even when variations occur in the values of door opening/closing speed Vdr due to a tilt of the vehicle body 2 or the like, averaging the values enables generating learned value data close to the preference of the user.

Moreover, the learning means 40 may be configured to perform learning to generate learned value data only when the tilt angle of the vehicle body 2 is less than or equal to a predetermined value.

For example, when the vehicle body 2 is tilted, the door opening/closing speed Vdr may differ from the preference of the user. In view of this, the learning means 40 may be configured not to perform learning when the tilt angle of the vehicle body 2 is greater than a predetermined value.

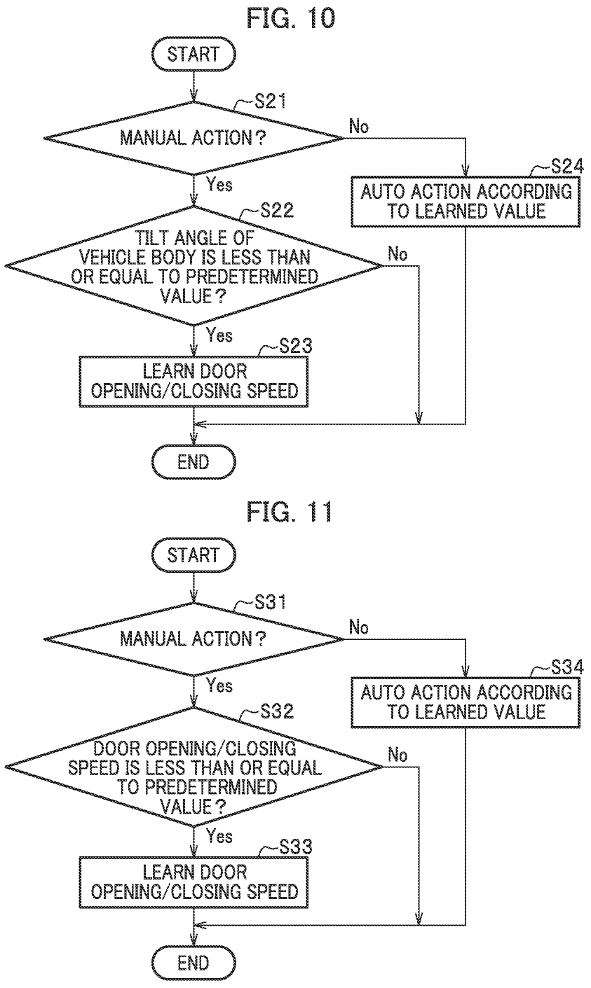

FIG. 10 is a flowchart illustrating control of detecting the tilt angle of the vehicle body 2 by the tilt angle sensor 60 (see FIG. 2) and choosing, based on the detected tilt angle, whether to learn the door opening/closing speed.

In step S21, the action determining section 30 of the controller 10 determines whether to open/close the door 3 with a manual action. When either the manual operation switch 5a or 6a of the door 3 is operated by the user, the action determining section 30 determines that an operation of opening or closing the door 3 is to be performed by a manual action (Yes at step S21) and the flow proceeds to step S22.

In step S22, determination is made as to whether the tilt angle of the vehicle body 2 is less than or equal to a predetermined value. When the tilt angle is determined as being less than or equal to the predetermined value in step S22 (Yes at step S22), the flow proceeds to step S23, and in step S23, the learning means 40 learns the values of door opening/closing speed Vdr detected by the door open/close detector 20.

When the tilt angle is determined as not being less than or equal to the predetermined value in step S22 (No at step S22), the controller 10 does not learn the door opening/closing speed Vdr values detected by the door open/close detector 20.

In step S21, when the action determining section 30 of the controller 10 determines that no manual action is to be performed (No at step S21), the flow proceeds to step S24 where the controller 10 outputs a control signal to which the learned value data has been reflected to the actuator 4 to perform an automatic action.

In this way, an irregular door opening/closing speed Vdr, e.g., too fast or too slow, that may possibly occur due to tilting of the vehicle body 2 is not included in the learned value data. Therefore, it is possible to cause the door 3 to operate automatically using learned value data close to the preference of the user.

The learning means 40 may be configured to perform learning only when the door opening/closing speed Vdr is less than or equal to a predetermined value to generate learned value data.

As illustrated in FIG. 11, in step S31, the action determining section 30 of the controller 10 determines whether an operation of opening or closing the door 3 is to be performed by a manual action. When either the manual operation switch 5a or 6a of the door 3 is operated by the user, the action determining section 30 determines that the operation of opening or closing the door 3 is to be performed by a manual action (Yes at step S31) and the flow proceeds to step S32.

In step S32, determination is made as to whether the door opening/closing speed Vdr converted from a detection signal is less than or equal to a predetermined value. When the values of the door opening/closing speed Vdr are determined as being less than or equal to a predetermined value (Yes at step S32), the flow proceeds to step S33, and in step S33, the learning means 40 learns the values of the door opening/closing speed Vdr to generate learned value data. When the values of door opening/closing speed Vdr is determined as not being less than or equal to the predetermined value (No at step S32), the learning means 40 does not learn the values of door opening/closing speed Vdr detected by the door open/close detector 20.

In step S31, when the action determining section 30 of the controller 10 determines that no manual action is to be performed (No at step S31), the flow proceeds to step S34 where the controller 10 outputs a control signal to which the learned value data is reflected to the actuator 4 to perform an automatic action.

In this way, a control signal based on the learned value data generated only from the values of door opening/closing speed Vdr less than or equal to the predetermined value is output from the controller 10 to the actuator 4.

Accordingly, excessive values of door opening/closing speed Vdr is not reflected to the automatic action of the door 3. As a result, even when the user has unwillingly opened or closed the door 3 with a fast speed in a manual action, the door 3 swings in the automatic action with values of door opening/closing speed Vdr that suit the preference of the user.

The door device 1 includes a user identification device 50 capable of recognizing a plurality of users separately.

The learning means 40 is further configured to further learn the door opening/closing speed Vdr on a per-user basis to generate the learned value data so as to associate values of the door opening/closing speed Vdr with users. Specifically, the learning means 40 includes a user-specific learning section 48 configured to, for each user recognized by the user identification device 50, perform learning and organize the learned value data to include user-specific learned value data in which the above-described opening degree-specific learned value data, the above-described position-specific learned value data, and the user location-specific learned value data are distinguished per user.

In this way, generating user-specific learned value data specific to individual user enables opening and closing the door 3 with values of door opening/closing speed Vdr more in line with the preference of individual user.

The present invention is not limited to the above-described embodiments, and allows various modifications. The above-described embodiment is exemplified to describe the present invention in an easily understandable manner, and the present invention is not limited to those including all the described components. In addition, a part of the configuration of a certain embodiment may be replaced with a part of the configuration of another embodiment, and the configuration of a certain embodiment may be added with a configuration of another embodiment. Further, a part of the configuration in each of the embodiments may be removed, added or replaced with other configuration. Examples of modifications possible to the above-described embodiment include the following.

In the case of the embodiment, the door open/close detector 20 is constructed including a Hall sensor for detecting the state of the rotation shaft of the motor actuator. However, the door open/close detector 20 for detecting the values of door opening/closing speed Vdr of the door 3 is not limited to a Hall sensor. The values of door opening/closing speed Vdr and/or the values of the door opening degree Odr may be obtained by computation using other speed sensor, angle sensor, rotation speed sensor and the like, for example by detecting time-series open/close angles of the door 3 using a rotation angle sensor to compute the values of door opening/closing speed Vdr. In other words, as long as the values of the door opening/closing speed Vdr of the door 3 can be used to generate learned value data by the learning means 40, the type of device for detection, detection method, and calculation means are not particularly limited.

The actuator 4 of the embodiment has been exemplified as a mechanism combining a motor actuator and a deceleration mechanism. The actuator 4 is not limited to this.

For example, the power mechanism that generates the driving force may be hydraulic or pneumatic, not limited to electric. Moreover, the transmission mechanism may be one that converts the driving force generated by the power mechanism into a force causing a swing action of the door 3 with respect to the vehicle body 2. Examples of such transmission mechanism include a ball screw mechanism and a link mechanism. In other words, the power mechanism and transmission mechanism used for the actuator 4 and the shape and quantity thereof are not limited as long as the actuator 4 drives the door 3 to open and close based on the control signal output by the controller 10.

The tilt angle sensor 60 is not limited to an acceleration sensor and may be a gyro sensor or another type of inertia sensor, for example. In other words, the detection method, structure, quantity, material, and installation position with respect to the vehicle body 2 is not particularly limited as long as the tilt angle sensor 60 is capable of detect the tilt angles of the vehicle body 2.

Moreover, the vehicle inner side switch 5 and vehicle outer side switch 6 are not limited to the configuration of the embodiment. The vehicle inner side switch 5 and the vehicle outer side switch 6 may be constructed in a discrete form or in a combined form, with the manual operation switch 5a and automatic operation switch 5b composing the vehicle inner side switch 5 and the manual operation switch 6a and automatic operation switch 6b composing the vehicle outer side switch 6.

The vehicle inner side switch 5 and the vehicle outer side switch 6 may be ones that detects operations of the user. Examples of such a switch include pushbutton switches, contact detection switches, and non-contact switches. The user identification device 50 may be one that recognizes the user inside or outside the vehicle compartment through communication, utilizing an ID key, remote control switch, or the like.

In other words, the forms, quantity, installation position, and method of detecting an operation by the user are not particularly limited as long as the vehicle inner side switch 5 and the vehicle outer side switch 6 enables determination of at least whether the user intends to perform a manual action.

What is claimed is:

1. A door device comprising:
a door swingable relative to a vehicle body;
an actuator configured to drive the door to open and close;
a controller configured to perform drive control on the actuator; and
a door open/close detector configured to detect an opening/closing speed of the door,
wherein the controller is configured to:
determine whether an opening/closing action to be performed on the door is a manual action, in which the door is to be manually opened or closed by a user, or an automatic action, in which the door is to be automatically opened or closed by the actuator; and
while the manual action is being performed, learn the opening/closing speed detected by the door open/close detector to generate learned value data including information on the opening/closing speed and to reflect the learned value data to the drive control on the actuator while the automatic action is being performed.

2. The door device according to claim 1,
wherein the controller is further configured to learn the opening/closing speed in relation to an opening degree of the door to generate the learned value data so as to include opening degree-specific learned value data in which values of the opening/closing speed are associated with values of the opening degree of the door.

3. The door device according to claim 2,
wherein the controller is further configured to learn the opening/closing speed in relation to the opening degree and in relation to an action start position of the door from which the manual action has started, to generate the learned value data so as to include position-specific learned value data in which the opening degree-specific learned value data is associated with the action start position, and
wherein when starting the automatic action, the controller reflects, of the position-specific learned value data, opening degree-specific learned value data corresponding to a current action start position of the door to the drive control on the actuator.

4. The door device according to claim 1,
wherein the controller is further configured to further learn the opening/closing speed separately for a case when the user is inside a vehicle compartment and a case when the user is outside the vehicle compartment.

5. The door device according to claim 1,
wherein the controller is further configured to calculate an average value of the opening/closing speed by averaging values of the opening/closing speed over a plurality of manual actions and include the average value into the learned value data as the information on the opening/closing speed.

6. The door device according to claim 1,
wherein the controller is further configured to learn the opening/closing speed only when a tilt angle of the vehicle body is less than or equal to a predetermined value.

7. The door device according to claim 1,
wherein the controller is further configured to learn the opening/closing speed only when the opening/closing speed is less than or equal to a predetermined value.

8. The door device according to claim 1,
wherein the door device further comprises a user identification device capable of recognizing a plurality of users separately, and
wherein the controller is further configured to further learn the opening/closing speed on a per-user basis to generate the learned value data so as to associate values of the opening/closing speed with users.
